(19) United States
(12) Patent Application Publication
(10) Pub. No.: US 2013/0280505 A1
(43) Pub. Date: Oct. 24, 2013

(54) DEVICE AND A METHOD FOR MARKING A SUBSTRATE AND A MARKING FOR A SUBSTRATE

(71) Applicant: REINHAUSEN PLASMA GMBH, Regensburg (DE)

(72) Inventor: Stefan Nettesheim, Berlin (DE)

(21) Appl. No.: 13/865,701

(22) Filed: Apr. 18, 2013

(30) Foreign Application Priority Data
Apr. 20, 2012 (DE) 102012103498.2

(51) Int. Cl. C23C 4/12; G06K 19/06

(52) U.S. Cl. CPC C23C 4/127; G06K 19/0614
USPC 428/199; 118/620; 427/446

(57) ABSTRACT

A device, a method for marking a substrate (14) with a plasma generator (5) and a corresponding marking are disclosed. A plasma jet (11) is directed onto the substrate (14) and is superimposed with a powder jet (12). In a powder dosing and dispersing unit (7), a powder (20) and a marker substance (30) in powder form are mixed. The marking forms an adhesive layer (15) of the powder (20) material in which a marker substance (30) is homogeneously distributed and permanently embedded.

### CROSS-REFERENCE TO RELATED APPLICATIONS

This application claims priority from German Patent Application No. 10 2012 103 498.2, filed on Apr. 20, 2012, which application is incorporated herein by reference in its entirety.

### FIELD OF THE INVENTION

The invention relates to a device for marking a substrate. The invention also relates to a method for marking a substrate. Furthermore, the invention relates to a marking for a substrate.

### BACKGROUND OF THE INVENTION

Devices and systems for marking goods clearly and in a forgery-proof manner become increasingly important. The issue of product piracy affects industries, like the vehicle, aviation and medical industries, with high safety standards and products where product forgery entrails serious safety risks. A variety of materials and procedures for unique an unambiguous marking are already available on the market. The procedures are based in part on micro-structuring, color marking, insertion of chemical or isotopic marker substances. It is likewise possible to insert genetic information into the goods.

The international patent application WO 2010/066 237 A1 discloses a method for authenticating and/or identifying an object. A chemical marking agent of the object encloses a marker as support and is essentially inseparable from it. The marker may comprise selected marking elements like chemical elements and/or compounds. The concentrations of the marking elements in the matrix define an encryption code. According to the disclosed method, initially a qualitative and/or quantitative determination of the marking elements of the chemical marking medium is performed. The values so obtained are then compared with select values in the before defined encryption code.

U.S. Pat. No. 5,867,586 discloses an authentication system comprising an ultraviolet light source in conjunction with a device for receiving and recognition of graphic images or letters or both. Based on the detected images, letters, images or combinations thereof it can be determined whether a given object is an original or a falsification.

U.S. Pat. No. 3,663,813 discloses symbols applied to a substrate by means of an encoded ink. The symbols are irradiated with ultra-violet light and the photoluminescence of the various symbols is transmitted to a camera via a dispersive element. The disclosed device thus permits the read-out of the symbols encoded on the substrate.

German patent application DE 10 2004 059 549 A1 discloses a method for coating a work piece. A coating material and an aggregate material are applied to the work piece by thermal spraying. In addition to the coating material an aggregate material is applied to the work piece. In the aggregate material a fluorescent marker material is firmly fixed. The spraying process is monitored online by detecting and evaluating at least the particles of the fluorescent marker material present in the spray jet.

A disadvantage of the prior art is that the marker substances applied onto the surfaces of the goods to be characterized are not durable. It is, however, necessary that the marker substances and the applied layers exhibit long lifetimes and also do not degenerate due to environmental conditions like, for example, thermal stress.

### BRIEF SUMMARY OF THE INVENTION

It is an object of the invention to create a device for marking a substrate or a good with a durable, reliable and stable coding by means of a thermal spraying method and wherein the thermal spray method does not destroy or deteriorate the coding.

The above object is achieved by a device for marking a substrate comprising a plasma generator for generating a plasma jet which is directed onto the substrate; at least one first container containing powder and at least one second container containing a marker substance in powder form; a powder injector for generating a powder jet is arranged relative to the plasma generator such that the plasma jet and the powder jet are superimposed, such that a layer is formable on the substrate, wherein the powder jet is composed of the powder and of the marker substance in powder form; and a pulsed arc discharge is furnished by the plasma generator.

The above object is achieved by another embodiment of the device for marking a substrate. The device comprising a plasma generator for generating a plasma jet which is directed onto the substrate; at least a first container containing a powder and a marker substance in powder form; a powder injector for generating a powder jet is arranged relative to the plasma generator such that the plasma jet and the powder jet are superimposed, such that a layer is formable on the substrate, wherein the powder jet is composed of the powder and of the marker substance in powder form; and a pulsed arc discharge is furnished by the plasma generator.

Another objective of the invention is to provide a method to apply a permanent marking to a good. Additionally, the identification of the marking should be simple to read out and the method should permit the unambiguous distinction between originals and falsifications.

The above objective is achieved by a method for marking a substrate comprising the steps: extracting a powder and a marker substance in powder form from at least one first container or extracting a powder from at least one first container and a marker substance in powder form from at least a second container; generating a powder jet from a homogeneous dispersion of the powder and the marker substance in powder form; generating a plasma jet with a plasma generator; inserting the powder jet into the plasma jet; and superimposing the powder jet and the plasma jet.

Yet another objective of the invention is to provide a marking for a substrate that is durably resilient to environmental influences, such as thermal fluctuations, the exposure to chemicals, etc.

The above objective is achieved by a marking for a substrate comprising: a layer adhesive to the substrate formed by a thermal spraying process, wherein the layer is a powder mixture of a powder and a marker substance, wherein the powder forms a matrix in which the marker substance is homogeneously distributed and permanently embedded.

The device for marking a substrate comprises a plasma generator that directs a plasma jet onto the substrate. According to one embodiment, there are at least a first container with powder and at least a second container with a marker substance in powder form. It is also conceivable that at least one first container is provided containing the powder and the marker substance in powder form. Furthermore, a powder injector for forming a powder jet is assigned to the plasma generator. The plasma jet and the powder jet are superimposed, such that a layer is formed on the surface of the substrate which constitutes as a marking for the substrate. The deposited layer consists of the powder taken from at least a first container and the marker substance in powder form taken from at least a second container. According to the other embodiment, the powder and the marker substance in powder form are premixed and taken from at least one container. It is clear that there is more than one container wherein the powder and the marker substance in powder form are premixed. Each container holds different types of powder and/or marker substance in powder form.

The powder mixture is supplied to a powder injector for forming a powder jet. The powder injector is arranged relative to the plasma generator such that the plasma jet and the powder jet are superimposed. A layer composed of the molten powder and the embedded marker substance thus forms on the substrate.

In any embodiment of the device according to the invention, the at least one first container containing powder and the at least one second container containing the marker substance in powder form or the at least one single container with the powder mixture can be connected to a powder dosing and dispersing unit. The powder mixture produced in powder dosing and dispersing unit is supplied to the powder injector together with a feed gas via a line. The powder dosing and dispersing unit serves to further homogenize the powder mixture, if necessary.

The powder injector is arranged in such a way relative to the plasma generator that the spatial expansion of a plasma jet from the plasma generator is greater than a spatial expansion of the powder jet from the powder injector at the site of the substrate. This special spatial arrangement of the plasma jet and the powder jet ensures that the entirety of the marker substances within powder mixture is embedded in a matrix of the powder material. The marker substance should be designed or selected such that its structure (e.g., lattice structure) remains unaltered during the deposition process on the substrate. In most instances, a thermal injection method is used for depositing the layer onto the substrate. In particular, the marker substance may be an inorganic powder mixture with characteristic lattice constant constituting unambiguous structural information. The marker substance in powder form and the powder that ultimately forms the matrix of the layer are subsequently deposited together by means of the plasma spraying method. Throughout the plasma spraying process the temperature is controlled such that the structural information of the marker substance is fully preserved. In addition, the plasma process provides a stable layer with high adhesive strength on the substrate. The particles of the marker substance are essentially homogeneously distributed within a polymer or metal or glass-like matrix of the powder. The powder melts during the plasma spraying method, and thus forms the matrix for the particles of the marker substance. The plasma generator produces a pulsed arc discharge.

According to the inventive method, a powder and a marker substance in powder form are extracted from at least one first container. By means of a powder injector, the homogeneous distribution of the powder and the marker substance in powder from are inserted into a plasma jet generated by a plasma generator. The plasma jet and a powder jet from the powder injector are superimposed.

According to another embodiment of the inventive method, a powder is extracted from the at least one first container. At the same time, a marker substance in powder form is extracted from the at least one second container.

The powder and the marker substance in powder form are supplied to a powder dosing and dispersing unit. The powder mixture may be taken from a single container or from a container with powder and a container with the marker substance in powder form. In the powder dosing and dispersing unit, the powder and the marker substance in powder form are mixed into a homogeneous mixture. The homogeneous mixture of the powder and the marker substance in powder form is provided to a powder injector. The powder injector forms a powder jet that is superimposed with a plasma jet from the plasma generator. The powder and the marker substance in powder form are thus deposited onto the substrate in a single step by means of a thermal spraying method.

A feed gas is added to the powder mixture exiting from the powder dosing and dispersing unit, in order to ensure a flowability of the powder mixture exiting from the plasma generator is generated by means of arc discharge. The powder jet composed of powder and marker substance in powder form is superimposed with the plasma jet. Thus, an adhesive layer is deposited on the substrate wherein the powder material forms a matrix in which the marker substance is homogeneously distributed and embedded. During the thermal spraying process, a temperature of the plasma jet is chosen such that structural properties of the marker substance are not altered. After application of the marking onto the substrate, the marker substance in the matrix has hence unchanged structural properties, corresponding to those of the marker substance in powder form.

The marking for a substrate consists of a layer that is deposited by a thermal spraying method and sticks to the substrate. The powder forms a matrix in which a marker substance is homogeneously distributed and permanently embedded. The marker substance embedded in the matrix has unchanged structural properties, corresponding to those structural properties of the marker substance in powder form. According to one possible embodiment, the marker substance in powder form can be coated with an embedding. The material of the embedding corresponds to that of the powder.

### BRIEF DESCRIPTION OF THE DRAWINGS

The invention is illustrated in greater detail by means of the figures, wherein:

FIG. 1 shows a schematic view of a first embodiment of the device for applying a marking onto a substrate;

FIG. 2 shows a schematic view of a further embodiment of the device for applying a marking onto a substrate;

FIG. 3 shows a schematic representation of a powder mixture consisting of the powder and the marker substance in powder form;

FIG. 4 shows a schematic representation of a powder mixture consisting of the powder and the embedded marker substance in powder form;

FIG. 5a shows a schematic representation of a layer with an embedded marker substance on the substrate;

FIG. 5b shows a layer with marker substance embedded in a deepening of the substrate;

and,

FIG. 6 shows a schematic arrangement for performing a detection method for substrate identification.

### DETAILED DESCRIPTION OF THE INVENTION

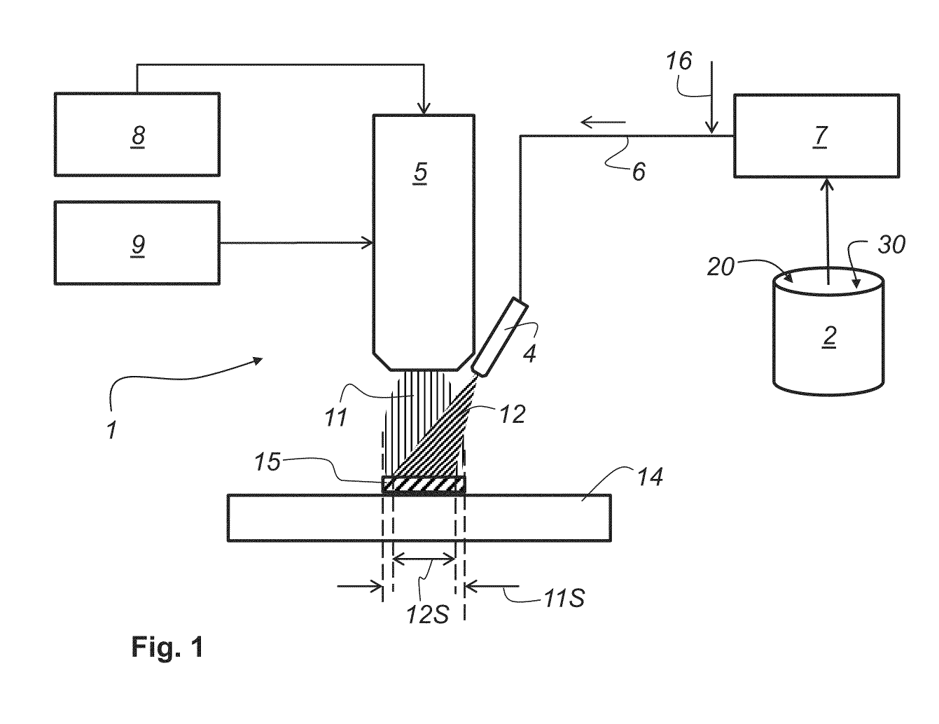

FIG. 1 shows a schematic view of the device 1 for coating a substrate 14. The deposition of a layer 15 is carried out using a thermal spraying method or a plasma coating process. Likewise feasible is a laser deposition method. Deposition is in any instance such that no loss of the information stored in a marker substance embedded within the layer 15 is incurred.

The embodiment described FIG. 1 uses a plasma deposition method for the application of the layer 15. By means of a plasma generator 5, a plasma jet 11 is generated and directed towards the substrate 14. The plasma generator 5 is provided with a power supply 9 and connected to a gas supply 8. The gas supply 8 is required for the plasma formation within the plasma generator 5. A powder injector 4 is allocated to the plasma generator 5. A powder mixture is fed to the powder injector 4, which is then superimposed with the plasma jet 11 as a powder jet 12 exiting from the powder injector 4.

The powder mixture is already provided as a mixture of powder 20 and a marker substance 30 in powder form in at least one first container 2. It and can be further homogenized in a downstream powder dosing and dispersing unit 7 in which a homogeneous mixture of the powder 20 and the marker substance 30 in powder form is formed. Finally, a feed gas 16 is added to the powder mixture to enhance its flowability.

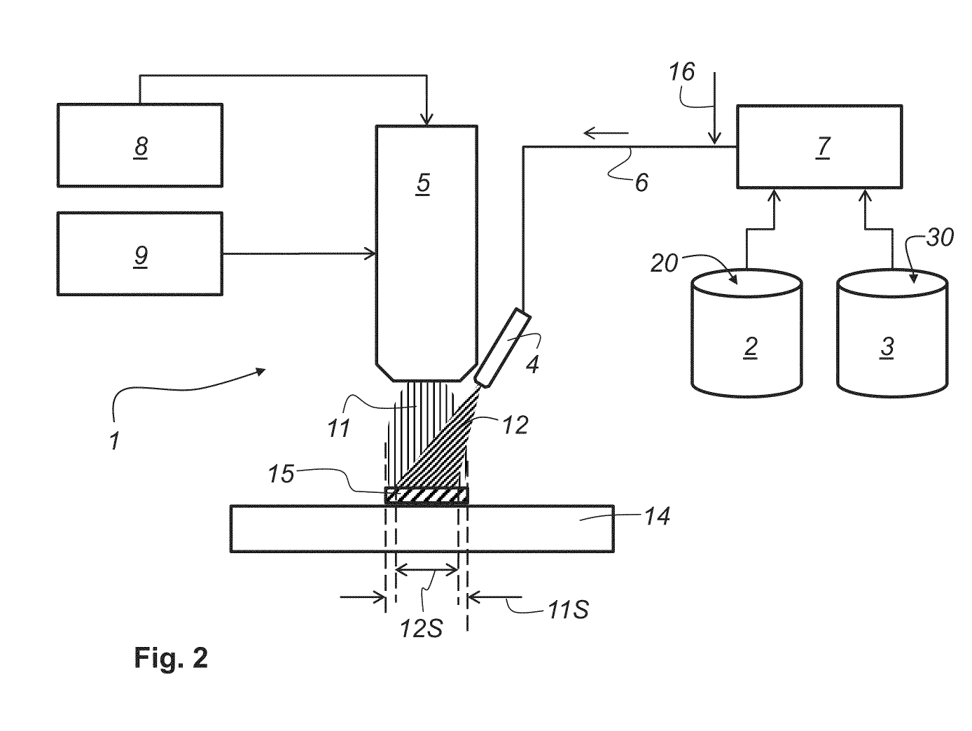

FIG. 2 shows a schematic view of a further embodiment of the device 1 for applying a marking to a substrate 14. The device 1 is essentially identical in structure with the device 1 from FIG. 1. The powder mixture 6 is made from powder 20 from at least one first container 2 and marker substance 30 in powder form from at least one second container 3. The powder 20 and the marker substance 30 in powder form are supplied to a powder dosing and dispersing unit 7, in which a homogeneous mixture of the powder 20 and the marker substance 30 in powder form is formed. A feed gas 16 is finally added to the powder mixture for enhanced flowability.

As shown in FIG. 1 and FIG. 2 the layer is formed from the powder 20 from the first container 2 and the marker substance 30 is embedded a matrix 25 resulting from the melting of the powder 20 which is achieved by superimposing the plasma jet 11 and the powder jet 12. The matrix 25 can be made from metals, polymers or glasses, etc. The layer 15 deposited by the plasma coating method thus adheres permanently on the substrate 14. The powder injector 4 is arranged relative to the plasma generator 5 such that a spatial extension 11S of the plasma jet 11 is greater than a spatial extension 12S of the powder jet 12 on the substrate 14.

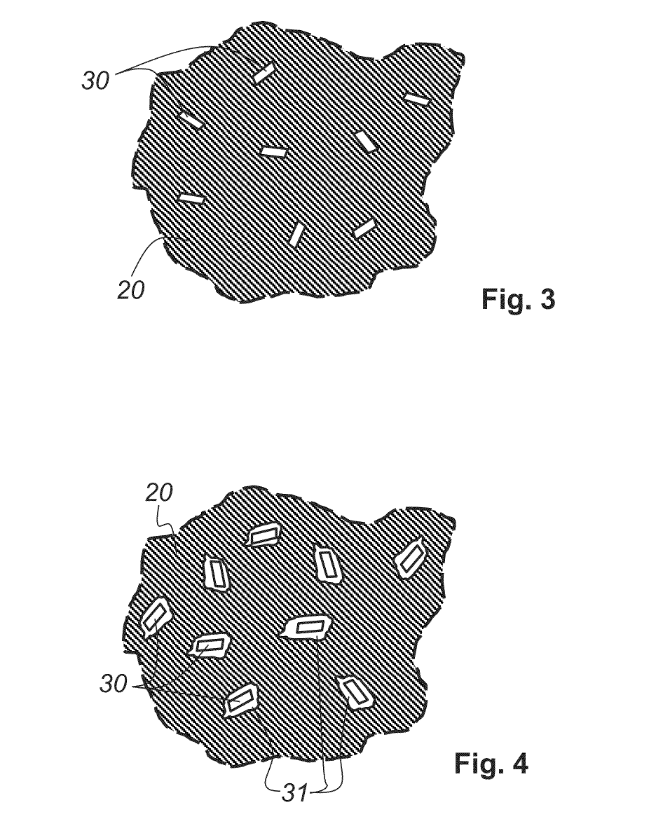

FIG. 3 shows a schematic view of the distribution of the particles of the marker substance 30 within the powder 20, wherein the powder 20 and the marker substance 30 are already mixed in a container 20 according to a predefined ratio.

FIG. 4 shows another possibility of the mixture of the particles of the marker substance 30 and the powder 20. The particles of the marker substance 30 are coated with an embedding 31. The embedding 31 corresponds to the material of the molten powder 20 which forms the matrix 25. In this proposed embodiment, a reliable connection of the marker substance 30 to the matrix 25 is achieved during plasma coating method. The particles of the marker substance 30 with the embedding 31 and the powder 20 are likewise in a container 20 mixed according to a predefined ratio. The particles of the marker substance 30 with of the embedding 31 and the powder 20 may, of course, be alternatively provided in separate containers.

It is advantageous if the premixed powder mixture from powder 20 and the marker substance 30 in powder form are supplied to the powder dosing and dispersing unit 7 for further homogenization. Of course, the powder mixture may also be fed directly from the container 20 the powder injector 4.

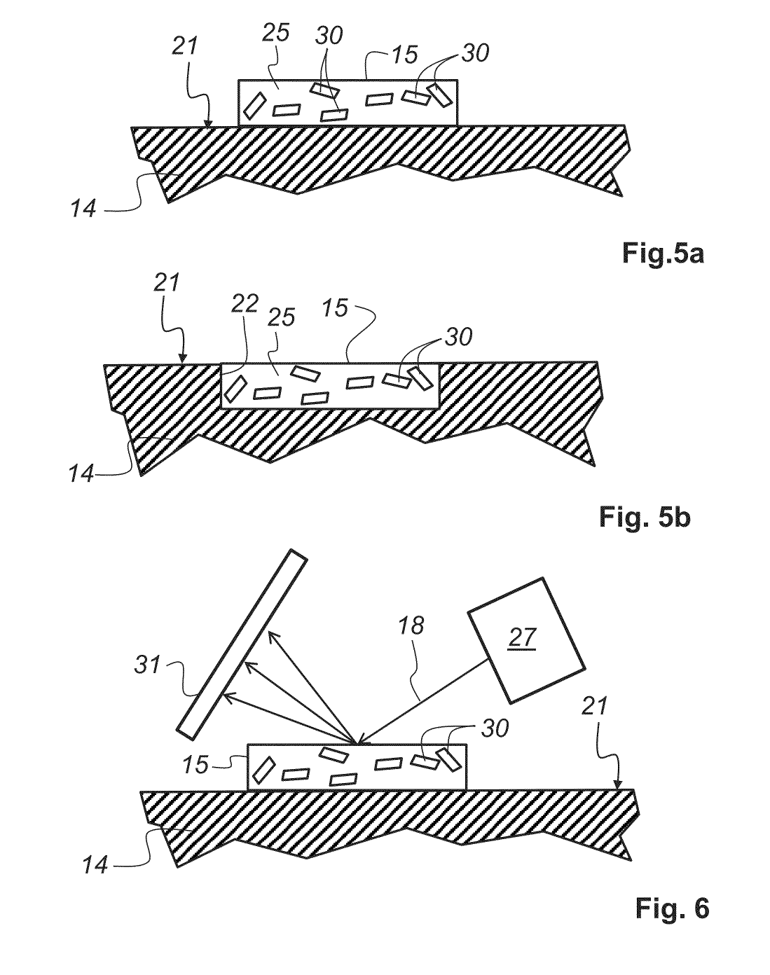

FIG. 5a shows a schematic view of the layer 15 applied onto the surface 21 of the substrate 14. The powder 20 in the powder mixture provides the matrix 25 in which the particles of the marker substance 30 are embedded. The distribution of the marker substance 30 within the matrix 25 is homogeneous.

FIG. 5b represents a further embodiment of the layer 15 provided on the substrate 14. The substrate 14 carries a deepening 22 in which the layer 15 is deposited by means of a plasma powder coating process. Therein, the particles of the marker substance 30 are homogeneously distributed within the matrix 25 formed by the at least partly molten powder 20 material.

FIG. 6 shows a schematic view of the detection arrangement for checking whether the layer 15 deposited on the substrate 14 carries the correspondingly defined characteristic identification features. The characteristic lattice constant of the marker substance 30 can easily be read out, for example by means of a scattering and/or diffraction setup. An x-ray source 27 directs an x-ray beam 18 onto the layer 15. The x-rays diffracted by the marker substance 30 are fed to a detector 31. Based on the signals registered by the detector 31, it can easily be determined which marker substance 30, if any, has been embedded in the matrix 25 of the layer 15.

By means of the plasma spraying method, the powder mixture is deposited on the surface 21 of the substrate 14. In this setup, the temperature of the plasma coating process is chosen such that the powder 20 component of the powder mixture melts while the characteristic and structural features of its marker substance 30 component are preserved. The structural information of the marker substance 30 thus remains completely intact while the layer sticks to the substrate 14 with high stability and adhesive strength. Even for very thin layers 15, the structural information is retrievable such that the product is marked unambiguously and is rendered forgery-proof.

A feasible example for such a forgery-proof marking is, that the marker substance 30 is mixed with a soldering means (powder 20), such as e.g., tin. Both marker substance 30 and tin are provided in powder form and are being mixed in the powder dosing and dispersing unit 7 of a device 1 according to the invention. Subsequently, the corresponding conductor tracks are applied by means of the spraying process. In these conductor tracks, the marker substance 30 is embedded. The conductor tracks can be, for example, the conductor tracks of photovoltaic cells or 3-dimensional structures for contacting of other components.

Another feasible field of application for the marker substance 30 is given by metallic layers on polymer structures. Here, the powder mixture is likewise constituted by the marker substance 30 and a metallic powder 20 ultimately forming the matrix 25 for the characterization. The metallic layers on polymer structures are used, for example, for EMC shielding or as conductive tracks in housings of electronic devices. During the plasma spraying process, the metal powder 20 components are molten and the marker substance 30 is embedded in the matrix 25 formed by the metallic components.

As already mentioned in the above, the powder mixture contains components allowing for its unambiguous and forgery-proof identification. Particularly suitable are inorganic components with specific lattice constants, allowing for unambiguous analysis by for example,

X-ray diffraction. By combining a plurality of such substances unknown to the general public (marker substances), a code can be defined that is both forgery-proof and rapidly and clearly legible. The read-out process is quick and simple to carry out and the writing process is proof against forgery. If particularly temperature-stable and chemically inert compounds are selected, the marking can be carried out with very small amounts of the marker substance 30 deposited by means of a plasma deposition method and a subsequent embedding in a matrix 25 of metals, polymers or glasses. Particularly suitable for the deposition is a plasma powder deposition method in which the temperatures can be limited such that, while the structural information encoded in the marker substance is preserved, a highly stable and well-adhering layer 15 is deposited on the substrate 14.

What is claimed is:

1. A device for marking a substrate comprising:
a plasma generator for generating a plasma jet which is directed onto the substrate;
at least one first container containing powder and at least one second container containing a marker substance in powder form;
a powder injector for generating a powder jet is arranged relative to the plasma generator such that the plasma jet and the powder jet are superimposed, such that a layer is formable on the substrate, wherein the powder jet is composed of the powder (20) and of the marker substance in powder form; and,
a pulsed arc discharge is furnished by the plasma generator.

2. The device recited in claim 1, wherein the at least one first container and at least one second container are connected to a powder dosing and dispersing unit, wherein a homogenized powder mixture in the powder dosing and dispersing unit is feedable via a line together with a feed gas to the powder injector.

3. The device recited in claim 1, wherein the powder injector is arranged relative to the plasma generator such that a spatial extension of the plasma jet is greater than a spatial extension of the powder jet on the substrate.

4. A method for marking a substrate comprising the steps:
extracting a powder and a marker substance in powder form from at least one first container or extracting a powder from at least one first container and a marker substance in powder form from at least a second container;
generating a powder jet from a homogeneous dispersion of the powder and the marker substance in powder form;
generating a plasma jet with a plasma generator;
inserting the powder jet into the plasma jet; and,
superimposing the powder jet and the plasma jet.

5. The method recited in claim 4, wherein the powder and the marker substance in powder form are mixed in a powder dosing and dispersing unit, such that there is a homogeneous distribution of the marker substance in powder form in the powder.

6. The method recited in claim 5, wherein a feed gas is added to the powder mixture exiting the powder dosing and dispersing unit.

7. The method recited in claim 4, wherein the plasma jet exiting the plasma generator is generated by arc discharge wherein with the plasma jet a layer adhesive to the substrate is deposited onto the substrate from the superposition of the powder jet containing powder and marker substance in powder form and within the layer the powder forms a matrix in which the marker substance is homogeneously distributed and embedded.

8. The method recited in claim 4, wherein a temperature of the plasma jet is chosen such that the structural properties of the marker substance distributed and embedded in the adhesive layer are not altered.

9. A marking for a substrate, comprising:
a layer adhesively secured to the substrate formed by a thermal spraying process, wherein the layer is a powder mixture of a powder and a marker substance, wherein the powder forms a matrix in which the marker substance is homogeneously distributed and permanently embedded.

10. The marking recited in claim 9, wherein the marker substance embedded in the matrix has unaltered structural properties with respect to those structural properties which the marker substance had in powder form.

11. The marking recited in claim 9, wherein the powder mixture is composed of powder from a first container and from the marker substance in powder form from a second container.

12. The marking recited in claim 9, wherein the powder and the marker substance in powder are mixed in a single container and the powder mixture is extractable from the single container.

13. The marking recited in claim 9, wherein the marker substance in powder form is surrounded with an embedding, wherein the material of the embedding corresponds to the material of the powder.

14. A device for marking a substrate comprising:
a plasma generator for generating a plasma jet which is directed onto the substrate;
at least a first container containing a powder and a marker substance in powder form;
a powder injector for generating a powder jet is arranged relative to the plasma generator such that the plasma jet and the powder jet are superimposed, such that a layer is formable on the substrate, wherein the powder jet is composed of the powder and of the marker substance in powder form; and,
a pulsed arc discharge is furnished by the plasma generator.

15. The device recited in claim 1, wherein the at least one first container is connected to a powder dosing and dispersing unit, wherein a homogenized powder mixture in the powder dosing and dispersing unit is feedable via a line together with a feed gas to the powder injector.

16. The device recited in claim 1, wherein the powder injector is arranged relative to the plasma generator such that a spatial extension of the plasma jet is greater than a spatial extension of the powder jet on the substrate.
